(19) United States
(12) Patent Application Publication
(10) Pub. No.: US 2016/0378529 A1
(43) Pub. Date: Dec. 29, 2016

(54) UTM INTEGRATED HYPERVISOR FOR VIRTUAL MACHINES

(71) Applicant: Fortinet, Inc., Sunnyvale, CA (US)

(72) Inventor: Guangchun Wen, Vancouver (CA)

(73) Assignee: Fortinet, Inc., Sunnyvale, CA (US)

(21) Appl. No.: 14/754,393

(22) Filed: Jun. 29, 2015

(51) Int. Cl. G06F 9/455; H04L 29/06

(52) U.S. Cl. CPC G06F 9/45558; H04L 63/02; H04L 63/0209; H04L 63/0272; G06F 2009/45587

(57) ABSTRACT

Systems and methods for integrating firewall and Unified Threat Management (UTM) features directly within a hypervisor are provided. According to one embodiment, a system is provided that includes multiple virtual machines (VMs) and an integrated hypervisor that manages the VMs. The integrated hypervisor has integrated therein a unified threat management (UTM) layer. In operation, the integrated hypervisor intercepts network traffic directed to or originated by the VMs and provides network security using the UTM layer.

### COPYRIGHT NOTICE

Contained herein is material that is subject to copyright protection. The copyright owner has no objection to the facsimile reproduction of the patent disclosure by any person as it appears in the Patent and Trademark Office patent files or records, but otherwise reserves all rights to the copyright whatsoever. Copyright © 2015, Fortinet, Inc.

### BACKGROUND

Field

Embodiments of the present invention generally relates to virtualization. More particularly, embodiments of the present invention relate to a hypervisor configuration and management for virtual machines in a virtualized computing architecture.

Description of the Related art

A virtual machine (VM) is a portion of software that, when executed on appropriate hardware, creates an environment allowing the virtualization of the resources of an actual physical computer system (e.g., a server, a mainframe computer, etc.). The actual physical computer system is typically referred to as a “host machine” or a “physical machine,” and the operating system of the host machine is typically referred to as the “host operating system.”

A virtual machine may function as a self-contained platform, executing its own “guest” operating system and software applications. Typically, software on the host machine known as a “hypervisor” (or a “virtual machine monitor”) manages the execution of one or more virtual machines, providing a variety of functions such as virtualizing and allocating resources, context switching among virtual machines, etc. Multiple operating systems run concurrently on a single physical computer and share hardware resources with each other. By encapsulating an entire machine, including CPU, memory, operating system, and network devices, a virtual machine is completely compatible with most standard operating systems, applications, and device drivers. Most modern implementations allow several operating systems and applications to safely run at the same time on a single computer, with each having access to the resources it needs when it needs them. Virtualization allows one to run multiple virtual machines on a single physical machine, with each virtual machine sharing the resources of that one physical computer across multiple environments. Different virtual machines can run different operating systems and multiple applications on the same physical computer. A hypervisor allocates a set of physical hardware resources dynamically and transparently to the VM such that the applications and the operating system running within the VM are not made aware that they are running on a virtualized platform.

In order to protect VMs, users/administrators typically need to deploy additional firewall/network security device hardware such as for intrusion prevention, creating proxies, packet monitoring/filtering, among other features. This architecture requires the kernel of the virtual architecture to redirect incoming traffic to the external network security devices for packet processing before locally processing the incoming traffic, thereby consuming additional time and resources. Another option is to use a firewall VM guest, but it is difficult to provide high performance using such architecture due to overhead of the VM guest.

There is therefore a need for a system and method that increases the efficiency of virtualization architecture by optimizing the management and configuration of the hypervisor.

### SUMMARY

Systems and methods are described for integrating firewall and Unified Threat Management (UTM) features directly within a hypervisor. According to one embodiment, a system is provided that includes multiple virtual machines (VMs) and an integrated hypervisor that manages the VMs. The integrated hypervisor has integrated therein a unified threat management (UTM) layer. In operation, the integrated hypervisor intercepts network traffic directed to or originated by the VMs and provides network security using the UTM layer.

Other features of embodiments of the present invention will be apparent from the accompanying drawings and from the detailed description that follows.

### BRIEF DESCRIPTION OF THE DRAWINGS

The accompanying drawings are included to provide a further understanding of the present disclosure, and are incorporated in and constitute a part of this specification. The drawings illustrate exemplary embodiments of the present disclosure and, together with the description, serve to explain the principles of the present disclosure.

FIG. 1 illustrates an existing virtualization architecture showing interactions between user space and kernel space.

FIG. 2 illustrates an exemplary architecture of a virtualization architecture having a hypervisor integrated with a unified threat management (UTM) layer in accordance with an embodiment of the present invention.

FIG. 3 illustrates another exemplary architecture of a virtualization architecture having a hypervisor integrated with a UTM layer and operatively coupled with a virtual private network (VPN) gateway in accordance with an embodiment of the present invention.

FIG. 4 illustrates yet another exemplary architecture of a virtualization architecture having a hypervisor integrated with a UTM layer in accordance with an embodiment of the present invention.

FIG. 5 is an exemplary computer system in which or with which embodiments of the present invention may be utilized.

### DETAILED DESCRIPTION

Systems and methods are described for integrating firewall and Unified Threat Management (UTM) features directly within a hypervisor. Embodiments of the present invention may be provided as a computer program product, which may include a machine-readable storage medium tangibly embodying thereon instructions, which may be used to program a computer (or other electronic devices) to perform a process. The machine-readable medium may include, but is not limited to, fixed (hard) drives, magnetic tape, floppy diskettes, optical disks, compact disc read-only memories (CD-ROMs), and magneto-optical disks, semiconductor memories, such as ROMs, PROMs, random access memories (RAMs), programmable read-only memories (PROMs), erasable PROMs (EPROMs), electrically erasable PROMs (EEPROMs), flash memory, magnetic or optical cards, or other type of media/machine-readable medium suitable for storing electronic instructions (e.g., computer programming code, such as software or firmware).

Various methods described herein may be practiced by combining one or more machine-readable storage media containing the code according to the present invention with appropriate standard computer hardware to execute the code contained therein. An apparatus for practicing various embodiments of the present invention may involve one or more computers (or one or more processors within a single computer) and storage systems containing or having network access to computer program(s) coded in accordance with various methods described herein, and the method steps of the invention could be accomplished by modules, routines, subroutines, or subparts of a computer program product.

If the specification states a component or feature “may”, “can”, “could”, or “might” be included or have a characteristic, that particular component or feature is not required to be included or have the characteristic.

Exemplary embodiments will now be described more fully hereinafter with reference to the accompanying drawings, in which exemplary embodiments are shown. This invention may, however, be embodied in many different forms and should not be construed as limited to the embodiments set forth herein. These embodiments are provided so that this disclosure will be thorough and complete and will fully convey the scope of the invention to those of ordinary skill in the art. Moreover, all statements herein reciting embodiments of the invention, as well as specific examples thereof, are intended to encompass both structural and functional equivalents thereof. Additionally, it is intended that such equivalents include both currently known equivalents as well as equivalents developed in the future (i.e., any elements developed that perform the same function, regardless of structure).

Thus, for example, it will be appreciated by those of ordinary skill in the art that the diagrams, schematics, illustrations, and the like represent conceptual views or processes illustrating systems and methods embodying this invention. The functions of the various elements shown in the figures may be provided through the use of dedicated hardware as well as hardware capable of executing associated software. Similarly, any switches shown in the figures are conceptual only. Their function may be carried out through the operation of program logic, through dedicated logic, through the interaction of program control and dedicated logic, or even manually, the particular technique being selectable by the entity implementing this invention. Those of ordinary skill in the art further understand that the exemplary hardware, software, processes, methods, and/or operating systems described herein are for illustrative purposes and, thus, are not intended to be limited to any particular named.

Systems and methods are described for integrating firewall and Unified Threat Management (UTM) features directly within a hypervisor.

Aspects of the present disclosure relate to a system incorporating at least one virtual machine that is managed by an integrated hypervisor, wherein the integrated hypervisor includes a hypervisor that is integrated with a unified threat management (UTM) layer such that the integrated hypervisor intercepts data flow of the at least one virtual machine and provides network security using the unified threat management layer.

In an aspect, the integrated hypervisor can be operatively coupled with a network processor that is offloaded the processing of the unified threat management layer. In another aspect, the network processor can be configured to perform any or a combination of data encryption, data decryption, and data acceleration.

In another aspect, the integrated hypervisor can be configured to intercept and scan data flows between the at least one virtual machine and an external network (e.g., the Internet). The integrated hypervisor can further be configured to, based on the unified threat management layer, provide any or a combination of packet security, port scanning, prevention of network attacks, load balancing, prevention of denial of service attacks, packet filtering, flow control, packet monitoring, anti-virus, and intrusion prevention system services. In an exemplary implementation, the integrated hypervisor can intercept and scan data flows between one or more virtual machines that the integrated hypervisor is coupled with, and, based on the unified threat management layer, provides any or a combination of packet security, port scanning, prevention of network attacks, load balancing, prevention of denial of service attacks, packet filtering, flow control, packet monitoring, anti-virus, and intrusion prevention system services.

In another embodiment, the integrated hypervisor can be configured to use virtualization techniques to present a software interface to the at least one virtual machine to reduce overhead of the at least one virtual machine. In another embodiment, the integrated hypervisor can be operatively coupled with a remote virtual private network (VPN) gateway, and wherein the VPN gateway can be configured to provide encryption service to the at least one virtual machine.

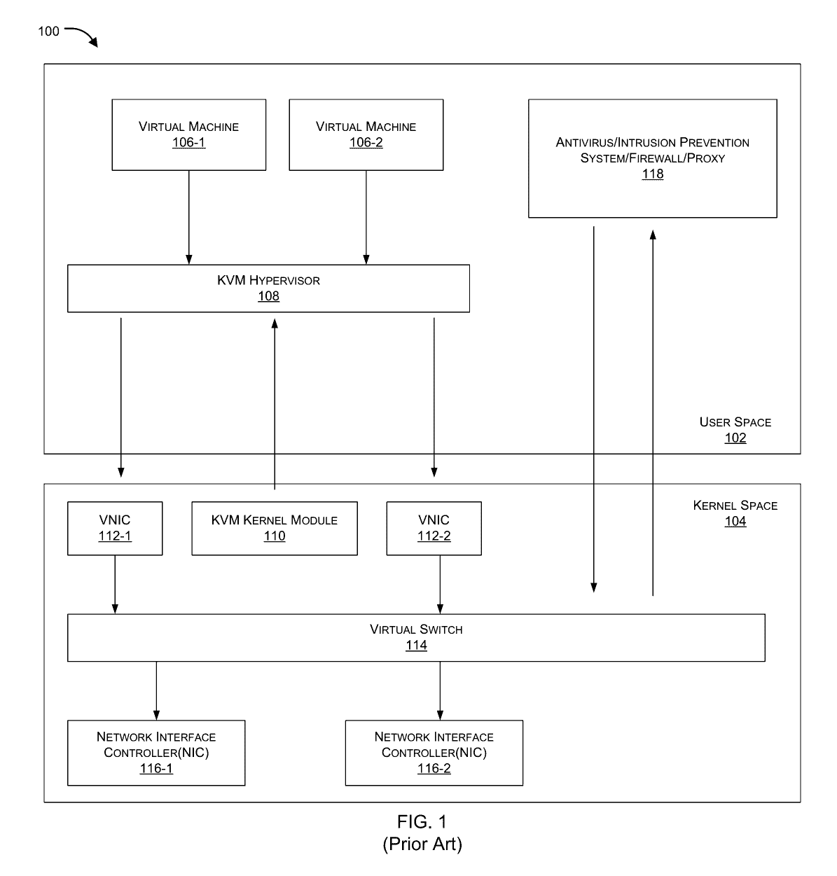

FIG. 1 illustrates an existing virtualization architecture 100 showing interactions between user space 102 and kernel space 104. Virtualization environment/architecture 100 can be implemented by a computer hardware that can be configured to execute a virtualization platform, which is a layer of software running directly on the computer hardware and which replaces the traditional operating system. The platform allows the computer hardware to execute multiple operating systems concurrently such as a Microsoft operating system, a Linux operating system, Solaris, NetBSD, FreeBSD, and others. The privileged domain may execute under any of a variety of operating systems as well. Each operating system then may execute independently of the others and therefore each is considered a virtual machine (VM).

User space 102 includes a kernel-based virtual machine (KVM) hypervisor 108 that can be operatively coupled with and configured to run/execute one or more virtual machines 106 (such as 106-1, 106-2, and so on). Kernel space 104, on the other hand, includes virtual network interface controllers (VNICs) 112 (such as VNIC 112-1 and VNIC 112-2) that correspond to respective virtual machines 106, and a KVM kernel module 110 that is operatively coupled with KVM hypervisor 108 to enable hypervisor 108 to use the services offered by kernel 110. VNICs 112 can be communicatively coupled with corresponding physical NICs 116 (such as 116-1 and 116-2) through say a virtual switch 114. KVM hypervisor 108 can be configured to create multiple VNICs 112 for each VM, which will appear in the kernel like any other physical NIC and enable a user to configure say a firewall policy between VNIC 112 and physical NIC 116.

VMs 106 can be hosted by one or more host machines (not shown), wherein the host machines may be a personal computer (PC), server computer, mainframe, or other computing system. The host machine can be a bare platform hardware that can include a processor, memory, input/output devices, etc. The host machine may be a single machine or multiple host machines arranged in a cluster. Host machine can include hypervisor 108 (also known as a virtual machine monitor (VMM)/KVM hypervisor 108), wherein hypervisor 108, though typically implemented in software, may emulate and export a bare machine interface to higher level software. Such higher level software may comprise a standard or real-time operating system (OS), may be a highly stripped down operating environment with limited operating system functionality that may not include traditional OS facilities, etc.

VMs 106 can be a combination of guest software that uses an underlying emulation of a hardware machine (e.g., as provided by hypervisor). The guest software may include a guest operating system and guest applications, guest device drivers, etc. VMs 106 can implement, for example, hardware emulation, full virtualization, para-virtualization, and operating system-level virtualization virtual machines. The guest OSs running on VMs 106 can be of the same or different types (e.g., all may be Windows® operating systems, or some may be Windows operating systems and the others may be Linux® operating systems).

Architecture 100 can further include, in user space 102, deployment of additional firewall/network security hardware 118 for protection of VMs 106, which significantly increases the overhead of the virtual machine guest. Virtual switch 114, through physical NICs 116, is in communication with one or more clients/devices and receives packets, which are then sent to network security devices 118 such as gateway/firewall/intrusion prevention/intrusion detection devices 118 for rule-based processing, and based on the outcome of which, devices 118 can then forward the packets back to switch 114 for onward transmission to VMs 106 using respective VNICs 112. Security devices 118 therefore send the processed packets back to kernel space 104, thereby further increasing the packet processing overhead of architecture 100.

In an alternative implementation, instead of virtual switch 214 processing the incoming packets, KVM hypervisor 108 can be given the responsibility of receiving the packets and sending them to network security device 118 and/or to a controller virtual machine, which can then control how the packets are to be processed by VMs 106. This implementation improves performance by intercepting VM traffic in user space 102 by KVM hypervisor 108 instead of in kernel space 104, reducing user space 102 to kernel space 104 pass through overhead. However, such a method is difficult to implement with current practices and open source tools, wherein if traffic is intercepted in kernel space 104, the same traffic has to go through user/kernel space twice.

There is therefore a need for an improved mechanism that increases the efficiency of virtualization architecture by optimizing the management and configuration of the hypervisor 108.

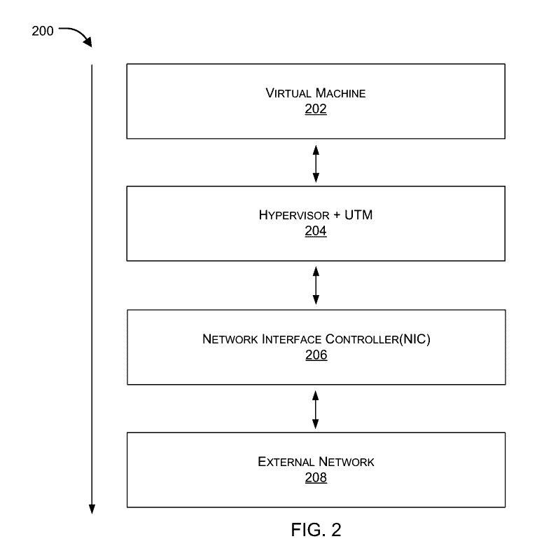

FIG. 2 illustrates an exemplary architecture 200 of a virtualization architecture having a hypervisor integrated with a unified threat management (UTM) layer in accordance with an embodiment of the present invention. As shown, architecture 200 comprises one or more VMs represented as 202, which can be managed/controlled by an integrated hypervisor 204 having a KVM hypervisor and a unified threat management (UTM) layer. Integrated hypervisor 204 can therefore include a hypervisor using para-virtualization technology that presents software interface (Para-API) to VMs that is similar but not identical to that of the underlying hardware, wherein an intent of such an interface is to reduce overhead and improve performance of VMs 202.

According to one embodiment, integrated hypervisor 204 can intercept data flow of VMs 202 by this para-API and can be configured to provide UTM (intrusion prevention system (IPS)/anti-virus (AV) and/or virtual private network (VPN)) services. Integrated hypervisor 204 can further be configured to offload various processing tasks to an application specific integrated circuit (ASIC) to achieve high performance. In an aspect therefore, integrated hypervisor 204 can be configured to provide at least one of a firewall service, an Internet Protocol Security (IPSec) service, a Virtual Private Network (VPN) service, a load balancing service, an intrusion detection and prevention system (IDS/IPS), a Unified Threat Management (UTM) service, data loss prevention (DLP) systems, Proxy/Gateway services, and other security services.

With reference to FIG. 2, integrated hypervisor 204 can be configured to receive packets from one or more NIC(s) 206 that interface with external network 208 such as the Internet.

Aspects of the present disclosure therefore relate to a system incorporating at least one VM 202 that is managed by an integrated hypervisor 204, wherein integrated hypervisor 204 includes a hypervisor that is integrated with a unified threat management (UTM) layer such that the integrated hypervisor intercepts data flow of the at least one VM and provides network security using the unified threat management layer.

In an aspect, integrated hypervisor 204 can be operatively coupled with a network processor to which processing of the unified threat management layer can be offloaded. In another aspect, the network processor can be configured to perform any or a combination of data encryption, data decryption, and data acceleration.

In another aspect, integrated hypervisor 204 can be configured to intercept and scan data flows between the at least one VM and Internet 208. Integrated hypervisor 204 can further be configured to, based on the unified threat management layer, provide any or a combination of packet security, port scanning, prevention of network attacks, load balancing, prevention of denial of service attacks, packet filtering, flow control, packet monitoring, anti-virus, and intrusion prevention system services. In an exemplary implementation, integrated hypervisor 204 can intercept and scan data flows between one or more VMs that integrated hypervisor 204 is coupled with, and, based on the unified threat management layer, provides any or a combination of packet security, port scanning, prevention of network attacks, load balancing, prevention of denial of service attacks, packet filtering, flow control, packet monitoring, anti-virus, and intrusion prevention system services.

In another embodiment, integrated hypervisor 204 can be configured to use virtualization techniques to present a software interface to the at least one virtual machine to reduce overhead of the at least one virtual machine. In another embodiment, the integrated hypervisor can be operatively coupled with a remote virtual private network (VPN), and wherein the VPN can be configured to provide encryption service to the at least one virtual machine.

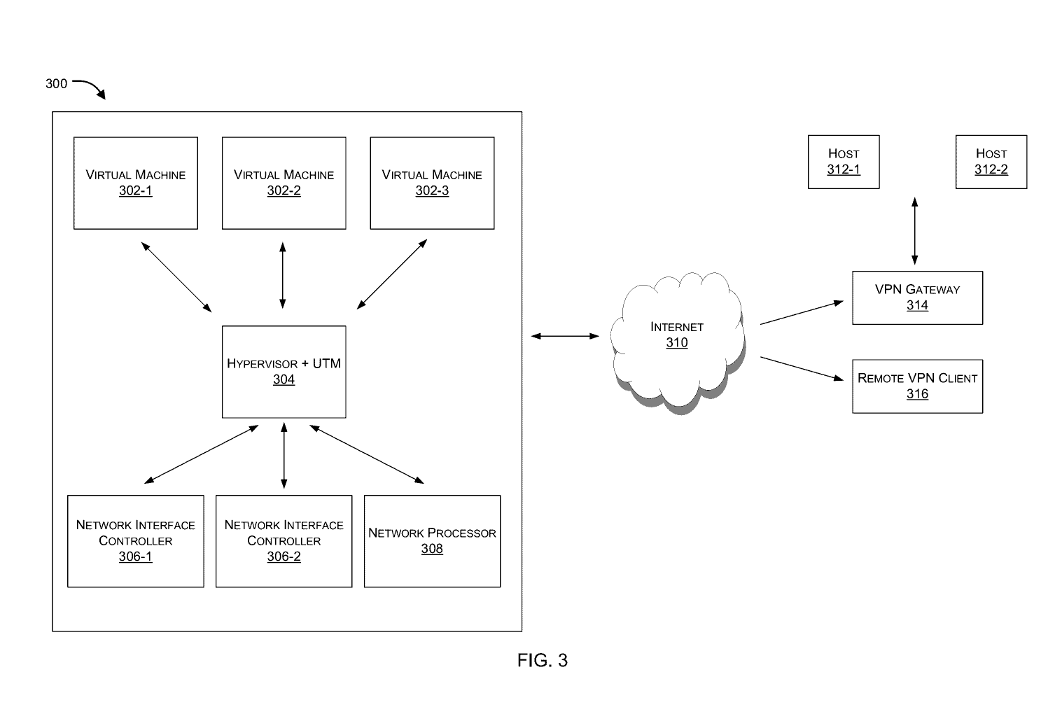

FIG. 3 illustrates another exemplary architecture 300 of a virtualization architecture having a hypervisor integrated with a UTM layer and operatively coupled with a virtual private network (VPN) gateway in accordance with an embodiment of the present invention. As shown, architecture 300 includes an integrated hypervisor 304 having a hypervisor integrated with a UTM layer configured to provide network security services for the operation of one or more VMs 302. Integrated hypervisor 304 can be configured to interface with any or a combination of a NIC such as 306-1 and 306-2 and a network processor (such as an ASIC) configured to perform the operations offloaded by integrated hypervisor 304.

According to one embodiment, virtualization architecture of the present disclosure can be operatively coupled with a VPN gateway 314 and/or a remote VPN client 316 through an external network such as Internet 310, wherein the VPN gateway 314 can be operatively coupled with one or more hosts such as 312-1 and 312-2. In an aspect, integrated hypervisor 304 can be configured to negotiate security key and other information with VPN gateway 314 to provide transparent encryption service to the VMs 302 installed on it. In another aspect, remote VPN gateway 314 can be a network controller and can be configured to implement one or more VPN protocols such as Internet Protocol Security (IPSec). In another aspect, integrated hypervisor 304 can utilize data encryption and decryption acceleration feature of the network processor 308 to provide high performance VPN service with little system CPU overhead.

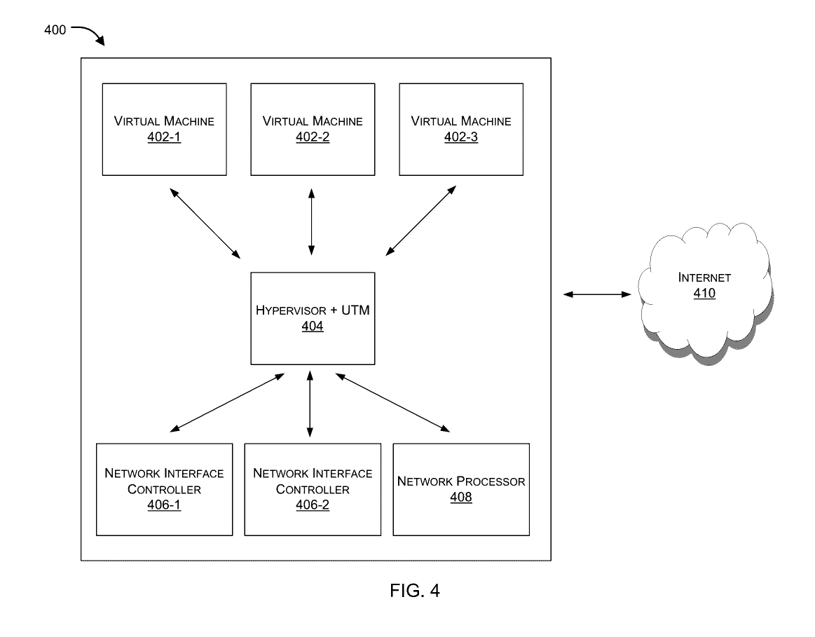

FIG. 4 illustrates yet another exemplary architecture 400 of a virtualization architecture having a hypervisor integrated with a UTM layer in accordance with an embodiment of the present invention. In an aspect, integrated hypervisor 404 can be configured to intercept and scan data flows between one or more VMs 402 and Internet 410 and/or between VMs 402 to provide AntiVirus and/or IPS services or any other security services.

As also explained above, integrated hypervisor 404 can be operatively coupled with one or more NICs 406 and at least one network processor 408. In yet another aspect, integrated hypervisor 404 can have an integrated feature and be configured to detect attacks such as Port Scanning, SYN flooding, and SYN spoofing. According to one embodiment, a Distributed Denial of Service (DDoS) detection feature of network controller 408 can detect and block DDoS attacks from the external network before it affects integrated hypervisor 404 and VMs 402. In yet another embodiment, integrated hypervisor 404 can be configured to load balance traffic to multiple VMs 402 on it, and can further be configured to provide load balancing typically performed by a network controller or other appropriate network device using techniques such as random, source IP Hash, round robin, weighted round robin, dynamic round robin load balancing.

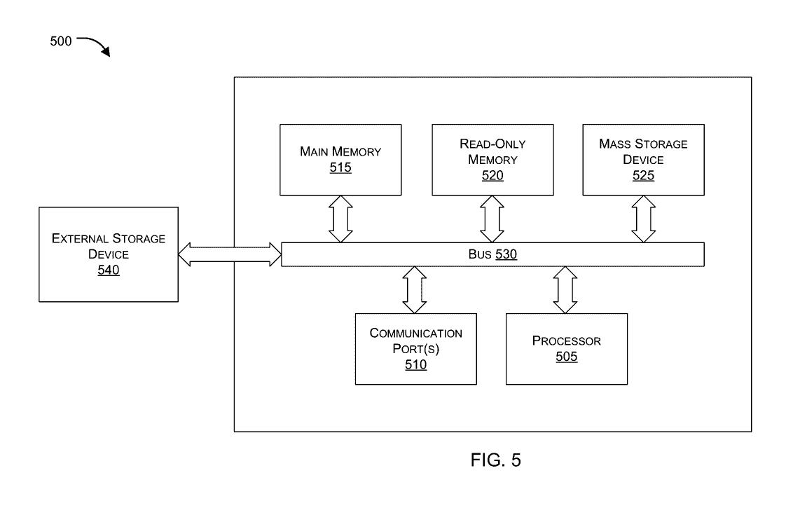

FIG. 5 is an exemplary computer system in which or with which embodiments of the present invention may be utilized. Embodiments of the present invention include various steps, which have been described above. A variety of these steps may be performed by hardware components or may be tangibly embodied on a computer-readable storage medium in the form of machine-executable instructions, which may be used to cause a general-purpose or special-purpose processor programmed with instructions to perform these steps. Alternatively, the steps may be performed by a combination of hardware, software, and/or firmware. As such, FIG. 5 is an example of a computer system 500, such as a server, a network security appliance or other network device, upon which or with which embodiments of the present invention may be employed.

According to the present example, the computer system includes a bus 530, one or more processors 505, one or more communication ports 510, a main memory 515, a removable storage media 540, a read only memory 520 and a mass storage 525.

Processor(s) 505 can be any future or existing processor, including, but not limited to, an Intel® Itanium® or Itanium 2 processor(s), or AMD®, Opteron® or Athlon MP® processor(s), or Motorola® lines of processors. Communication port(s) 510 can be any of an RS-232 port for use with a modem based dialup connection, a 10/100 Ethernet port, a Gigabit port using copper or fiber or other existing or future ports. Communication port(s) 510 may be chosen depending on a network, such as a Local Area Network (LAN), Wide Area Network (WAN), or any other network to which the computer system 500 connects. For example, in the context of a PBX, communication port(s) 510 may include communication cards supporting Ethernet or DS1/DS3 types of connections and in the context of a fax server, such as one of fax servers 341a-n, communication port(s) 510 may include Ethernet, DS0, T1/DS1 (such as ISDN PRI) or fractional T1/DS1 or digital DS0 (such as ISDN BRI).

Main memory 515 can be Random Access Memory (RAM), or any other dynamic storage device(s) commonly known in the art. Read only memory 520 can be any static storage device(s) such as Programmable Read Only Memory (PROM) chips for storing static information such as start-up or BIOS instructions for processor 505.

Mass storage 525 may be any current or future mass storage solution, which can be used to store information and/or instructions. Exemplary mass storage solutions include, but are not limited to, Parallel Advanced Technology Attachment (PATA) or Serial Advanced Technology Attachment (SATA) hard disk drives or solid-state drives (internal or external, e.g., having Universal Serial Bus (USB) and/or Firewire interfaces), such as those available from Seagate (e.g., the Seagate Barracuda 7200 family) or Hitachi (e.g., the Hitachi Deskstar 7K1000), one or more optical discs, Redundant Array of Independent Disks (RAID) storage, such as an array of disks (e.g., SATA arrays), available from various vendors including Dot Hill Systems Corp., LaCie, Nexsan Technologies, Inc. and Enhance Technology, Inc.

Bus 530 communicatively couples processor(s) 505 with the other memory, storage and communication blocks. Bus 530 can include a bus, such as a Peripheral Component Interconnect (PCI)/PCI Extended (PCI-X), Small Computer System Interface (SCSI), USB or the like, for connecting expansion cards, drives and other subsystems as well as other buses, such as front side bus (FSB), which connects the processor(s) 505 to system memory.

Optionally, operator and administrative interfaces, such as a display, keyboard, and a cursor control device, may also be coupled to bus 530 to support direct operator interaction with computer system 500. Other operator and administrative interfaces can be provided through network connections connected through communication ports 510.

Removable storage media 540 can be any kind of external hard-drives, floppy drives, IOMEGA® Zip Drives, Compact Disc-Read Only Memory (CD-ROM), Compact Disc-Re-Writable (CD-RW), Digital Video Disk-Read Only Memory (DVD-ROM). In no way should the aforementioned exemplary computer system limit the scope of the invention.

While embodiments of the present invention have been illustrated and described, it will be clear that the invention is not limited to these embodiments only. Numerous modifications, changes, variations, substitutions, and equivalents will be apparent to those skilled in the art, without departing from the spirit and scope of the invention, as described in the claim.

In the foregoing description, numerous details are set forth. It will be apparent, however, to one of ordinary skill in the art having the benefit of this disclosure, that the present invention may be practiced without these specific details. In some instances, well-known structures and devices are shown in block diagram form, rather than in detail, to avoid obscuring the present invention.

Some portions of the detailed description have been presented in terms of algorithms and symbolic representations of operations on data bits within a computer memory. An algorithm is here, and generally, conceived to be a self-consistent sequence of steps leading to a desired result. The steps are those requiring physical manipulations of physical quantities. Usually, though not necessarily, these quantities take the form of electrical or magnetic signals capable of being stored, transferred, combined, compared, and otherwise manipulated. It has proven convenient at times, for reasons of common usage, to refer to these signals as bits, values, elements, symbols, characters, terms, numbers, or the like.

It should be borne in mind, however, that all of these and similar terms are to be associated with the appropriate physical quantities and are merely convenient labels applied to these quantities. Unless specifically stated otherwise as apparent from the following discussion, it is appreciated that throughout the description, discussions utilizing terms such as “computing”, “comparing”, “determining”, “adjusting”, “applying”, “creating”, “ranking,” “classifying,” or the like, refer to the actions and processes of a computer system, or similar electronic computing device, that manipulates and transforms data represented as physical (e.g., electronic) quantities within the computer system's registers and memories into other data similarly represented as physical quantities within the computer system memories or registers or other such information storage, transmission or display devices.

Certain embodiments of the present invention also relate to an apparatus for performing the operations herein. This apparatus may be constructed for the intended purposes, or it may comprise a general-purpose computer selectively activated or reconfigured by a computer program stored in the computer. Such a computer program may be stored in a computer readable storage medium, such as, but not limited to, any type of disk including floppy disks, optical disks, CD-ROMs, and magnetic-optical disks, read-only memories (ROMs), random access memories (RAMs), EPROMs, EEPROMs, magnetic or optical cards, or any type of media suitable for storing electronic instructions.

It is to be understood that the above description is intended to be illustrative, and not restrictive. Many other embodiments will be apparent to those of skill in the art upon reading and understanding the above description. The scope of the invention should therefore be determined with reference to the appended claims, along with the full scope of equivalents to which such claims are entitled.

1-7. (canceled)

8. A computer system comprising:
a central processing unit (CPU) running a hypervisor that manages a plurality of virtual machines (VMs);
a plurality of network interface controllers (NICs), coupled to the CPU, through which the VMs are communicably coupled to an external network;
wherein the hypervisor is logically interposed between the plurality of NICs and the plurality of VMs and has integrated therein a unified threat management (UTM) layer having implemented therein one or more of intrusion prevention system (IPS) functionality, antivirus (AV) functionality and virtual private network (VPN) functionality; and
wherein the hypervisor provides network security on behalf of the plurality of VMs by intercepting network traffic directed to the plurality of VMs that is received via the plurality of NICs and causing the network traffic to be scanned by the UTM layer before allowing the network traffic to be received by the plurality of VMs.

9. The computer system of claim 8, further comprising a network processor to which the UTM layer offloads a portion of its processing.

10. The computer system of claim 9, wherein the network processor supports the VPN functionality by performing any or a combination of data encryption, data decryption, and data acceleration.

11. The computer system of claim 10, wherein the network processor is implemented in a form of an application-specific integrated circuit (ASIC).

12. A method comprising:
intercepting, by a hypervisor running on a central processing unit (CPU) of a computer system, network traffic received via a network interface controller (NIC) of the computer system that is directed to a virtual machine (VM) of a plurality of VMs managed by the hypervisor; and
providing, by the hypervisor, network security on behalf of the VM by causing the network traffic to be scanned by a unified threat management (UTM) layer integrated within the hypervisor, wherein the UTM layer performs one or more of intrusion prevention system (IPS) functionality, antivirus (AV) functionality and virtual private network (VPN) functionality.

13. The method of claim 12, wherein the computer system further includes a network processor and wherein said providing, by the hypervisor, network security on behalf of the VM by causing the network traffic to be scanned by a UTM layer integrated within the hypervisor includes the UTM layer offloading a portion of its processing to the network processor.

14. The method of claim 12, wherein the network processor supports the VPN functionality by performing any or a combination of data encryption, data decryption, and data acceleration.
